(19) United States
(12) Patent Application Publication
(10) Pub. No.: US 2009/0069936 A1
(43) Pub. Date: Mar. 12, 2009

(54) CONTROL METHOD FOR ROBOTS

(75) Inventors: Sonke Kock, Vasteras (SE); Colin Luthardt, Vasteras (SE); Christian H. Muller, Ladenburg (DE); Ake Olofsson, Vasteras (SE)

Correspondence Address: VENABLE LLP, P.O. BOX 34385, WASHINGTON, DC, 20043-9998, US

(73) Assignee: ABB AB, Vasteras (SE)

(21) Appl. No.: 10/588,525

(22) PCT Filed: Feb. 7, 2005
(86) PCT No.: PCT/SE2005/000176

§ 371 Date: Nov. 12, 2008

(30) Foreign Application Priority Data
Feb. 6, 2004 (SE) 0400320-8

(51) Int. Cl. B25J 9/16

(52) U.S. Cl. 700/254; 700/245; 901/42

(57) ABSTRACT

A method of an industrial robot including a control unit and a manipulator including a tool including a defined tool center point and a device for determining a distance error between an inaccurately programmed position for a spot on a surface of a work piece and a corresponding actual position.

### TECHNICAL FIELD

The present invention relates to an industrial robot system and a method of controlling. An industrial robot system is defined to comprise a control unit, a manipulator and a robot tool.

### BACKGROUND OF THE INVENTION

An industrial robot system comprises a manipulator and a control unit and is programmed to carry out work or a work at least one cycle along an operating path. In order to program or teach the work cycle, the robot is manipulated to positions and orientation along the desired operating path. These positions are stored as instructions in a memory in the control unit. Other information, such as desired robot movement velocity, may also be stored in the memory. During operation of the robot, the program instructions are executed, thereby making the robot operate as desired. There are always processes where it is necessary to correct distance errors between the programmed positions and the real world. One such process is spot welding.

Resistance spot welds are usually made automatically by an industrial robot carrying a resistance spot welding gun. The robot subsequently moves to the weld targets as defined in the robot program. The gun clamps to eliminate the air gap between the sheets of metal in a “work piece” to be joined. An electrical current is sent through the material, which creates enough local heat to melt the material and create a spot weld. Resistance spot welds can also be made by a stationary weld gun arrangement where an industrial robot is carrying the “work piece”.

The expression “work piece” will be employed below both in the body of this specification and in the appended Claims. This should be interpreted broadly and such interpretation for example encompasses at least two metal sheets laid against another, and may also include a partly finished or almost finished component which is composed of a plurality of different parts, the component per se being intended to be provided with a joint or to be supplemented with an additional part with the aid of joining in specific positions.

Programs for spot welding, e.g. of car bodies, are either created by teaching spot by spot by jogging the robot in the appropriate position, or by offline programming tools where robot and work cell are simulated on a PC. The first procedure is time consuming and the second procedure is faster but every spot has to be corrected manually by jogging the robot to the exact position the real cell due to differences between the simulation and the real world. Additionally it is often necessary to again correct the spots manually from time to time when the position of the work piece varies with changing of the part tolerances during production. Using the robot touch up the manual correction can be done automatically thus being faster with reduced costs and higher accuracy.

The method of touching up is defined as follows. The starting point is an inaccurately known position of a work piece, a well-defined TCP for the tip of a robot tool and a well-known direction to move the tip of the tool towards the work piece. Then, in a “touch up” the robot moves the tip of the tool in the defined direction until the tip touches (gets in contact with) the surface of the work piece. From the position of the robot and the definition of the TCP (which is the known position of the tip) it is possible to exactly determine the position of the work piece at the contact point with the tip.

In addition, a welding gun comprises arms including electrodes. During spot welding the welding tips of the electrodes wear over time since some material burns away with every weld and consequently the originally defined TCP becomes more and more inaccurate. Since the robot controller is not aware of this and the robot program is not modified accordingly, an increasing TCP error occurs. In this case a well-defined reference surface is needed. Touching up this reference surface with a worn tip gives the tip wear as the difference between the expected contact point and the touch up found contact point.

When the robot is positioned to a programmed target, an inaccurate defined target or a TCP error creates a gap between the tip of the robot tool and the surface of the work piece. During spot welding, for example, a spot weld gun clamps the work piece and it is the task of a gun equalizer to eliminate the gap without creating stress between the gun and the robot. Both the gun equalizer itself and the large effort for touching up spot weld targets are a great cost factor of spot welding systems.

There are mainly two types of weld guns, X-guns and C-guns. An X-gun comprises a first movable electrode arm and a second stationary electrode arm. In a C-gun a first welding electrode is movably arranged in a guide at one branch of the C and moves towards and away from an opposite fixed electrode arm.

A welding gun is usually controlled by compressed air or by a servo motor. For a pneumatic gun, the movement of the first electrode towards and away from the second electrode is achieved with a pneumatic cylinder.

In spot welding it is very important to know the exact position of the TCP, which is the tip of the electrode on the fixed gun arm. This position is however changed during use of the gun, statically but also dynamically. The statically changes are caused e.g. by electrode wear as mentioned above and tip dressing, where the electrode tip is reshaped. Dynamically, when the gun is closed and the tip force is applied the gun arms are deflected. Another factor that influences the position between TCP and work piece is inaccuracy in programming as mentioned above.

It is known to solve the above-mentioned problems by using an equalizing system, which ensures that the second fixed arm is brought in level with the “closest” sheet of the work piece to be welded. The equalizing system is arranged between the tool and the turntable of the robot hand. The equalizing system is, in principle, a clutch adapted to be disengaged. During movement of the tool, the equalizing system comprises a clutch in a fixed position and with the second fixed arm at a defined distance from the sheet. At the end phase of the closing movement of the gun and during the joining process, the clutch is disengaged such that the tool is able to move relative to the turning plate. It is general knowledge to use pneumatic or electrical equalizing systems.

Disadvantages of these equalizing systems are that they need expensive power supply and a lot of mechanics, which are again expensive and introduce additional weight to the spot welding gun. Another disadvantage is that equalizing systems behave differently heavy depending on how the tool is oriented is space due to the gravity dependency. Besides, there is a play.

Therefore, it would be interesting to have a solution without an expensive mechanical equalizing system. For such a solution the important items in industrial robot processes are that the TCP must be accurately defined and that the work positions are accurately taught or modified during programming especially for processes for working e.g. joining in specific positions.

In production, the important items are that the TCP is accurately defined and is adjusted after tool dressing and tool change and that the fixed gun arm is adapted to leave the surface of the object during the movement to next work position. Further, tool arm deflection is compensated and the variations of the position of the sheet metal are small between parts.

JP 10006018 shows a spot welder comprising a pair of secondary arms each provided with an electrode. The electrodes supply welding current to a welded object through the secondary arms. A predetermined welding force is given to the work piece by a servo mechanism of air, hydraulic or electric type. In the resistance spot welder, the second arm has an integral function as an elastic body for giving a prescribed pressure to the material to be welded.

WO 94/09939 discloses a method for automatic program compensation of electrode wear, commonly denoted equalizing, and a unit to which the gun is moved with some intervals. The unit comprises a device for measuring the position of the tip and by sending this information to the automatic unit adjusting the welding positions to this measurement. The fixed electrode tip is moved towards the sheet at the same time as the controller sends the signal to the welding gun to close.

JP 09-070675 discloses a controller for spot welding and its control method. The method includes automating the management of an electrode tip from the position correction of this tip based on wear. The moving side electrode tip is pressed to a reference stationary object and the difference, the wear is determined and stored.

JP 97-314146 shows a spot welding method and a device therefore with the purpose of increasing a continuous spotting speed by executing equalization action of a spot welding robot.

To sum up, accuracy is important and there is need for a control method for eliminating the manual handling part when doing touch up in specific position processes e.g. spot welding. Further, time is important for processes of joining in specific positions and there is a need for a less time consuming control method. There is also a need for an equalization method in a spot welding process for example, which eliminates the need of equalizer and of its power supply. There is also a need for a general robot control method suitable for different type of guns e.g. pneumatic guns, servo guns, X-guns and C-guns.

### SUMMARY OF THE INVENTION

A first object of the invention is to provide a method which eliminates both the use of a gun equalizer and the need for manually touching up robot programs. A second object of the invention is to provide a control method, which is accurate, fast and robust.

These objects are achieved according to the invention in a first aspect with a method of controlling an industrial robot system comprising the characteristic features of the independent claim 1, in a second aspect with a method of controlling an industrial robot system comprising the characteristic features of the independent method claim 7, in a third aspect with a method of calibrating an industrial robot comprising the characteristic features of the independent claim 12 and in a fourth aspect with a an industrial robot system device comprising the characterizing features of the independent claim 17. According to the invention, these objects also are achieved in a data program product comprising the characteristic features of the independent claim 21 and in a use according to the independent claim 23. Preferred embodiments are described in the dependent claims.

According to the first aspect, the invention provides a method of an industrial robot comprising a control unit and a manipulator including a tool with a tip comprising a defined TCP, for determining an actual position corresponding to an inaccurate programmed position for a spot on a surface of a work piece. The tip of the tool is brought to be moved from a first programmed position at a distance from the surface in a defined direction towards the work piece. The tip is brought to collide with the surface at a collision point. The actual position is computed from the distance between the position of the collision point and the first programmed position in the defined direction of movement.

In one preferred embodiment of the invention, the tool is brought to be moved towards a second position programmed to be positioned behind the work piece seen in the direction of movement to secure that the tool tip always is brought to collide with the work piece. The movement of the tip is brought to be stopped when a created force between the work piece and the tip has increased to a predefined value. In one preferred embodiment of the invention, the servo is set in normal control mode and the created force is brought to be detected by supervising motor torques of axes of the robot. In another preferred embodiment of the invention, the created force is brought to be controlled by soft servo.

The method has the advantage of being automatic and further more exact since the manual part activities are eliminated. The set up is faster compared to conventional (manual) methods and is suitable for joining processes working in specific positions e.g. spot welding, arc welding in specific positions, riveting or clinching. The method is also suitable for applications using laser for performing work in specific positions. In spot welding, the touch up method is possible to perform using a gun comprising a movable tool tip. This possibility excludes pneumatic spot welding guns.

When used in a spot welding process, the method has the advantage of being suitable to all kinds of spot welding guns comprising one fixed gun arm e.g. pneumatic or servo guns, because the method is performed with the spot welding gun opened. Further advantages are that there is no need to know neither the thickness of the sheet of the work piece nor the position of the surface of the work piece, due to the fact that the gun is opened when performing the method.

It is comprised in the scope of protection that the invention is suitable for stationary process apparatuses, where the tool is fixed in a stand and the work piece is held by an industrial robot.

Further, the method has also the advantage of being suitable for stationary spot welding apparatuses, where the spot welding gun is fixed in a stand and the work piece is held by an industrial robot.

In a preferred embodiment of the invention, the computed position is permanently stored in a memory of the control unit. Further, the robot is moved to a target corresponding to a second spot weld and the same procedure is repeated until all targets are processed. The method is preferably used when setting up an industrial robot spot welding cell.

In another preferred embodiment of the invention, the robot is moved in a normal control servo mode. Then, the contact with the work piece is detected by supervising the motor torques of the robot axes. With this method, the user can define in advance the allowed touch up force, the force between work piece and tip when the robot stops, depending on the actual application. In another preferred embodiment, the robot is moved in soft servo mode. Then, the force between the tool tip and the work object will increase, but not excessively. This is described under the heading of description of the preferred embodiments.

The second aspect of the invention provides a method of controlling an industrial robot, comprising a control unit and a manipulator including a tool comprising a defined TCP, for determining a distance error between a known position for a target on a surface of a calibration plate and a corresponding actual position due to wear of the tool, with the tool orientation normal to the surface. The robot is moved from a safe start position with the tool orientation normal to the surface such that the tool is brought in touch with the surface of the calibration plate, creating an actual position. An actual TCP position is read to define a coordinate system. Two reference distances are computed from the differences between the TCP positions of the actual position and the start position. The wear is computed by computing the difference between the two reference distances.

The method according to the second aspect of the invention has the same advantages and the same control methods are used as mentioned for the first aspect of the invention. Further, the method is used after tool dressing or after the tool has been exchanged. In a preferred embodiment, the method adjusts the TCP value and updates tool wear data in current tool data automatically. When used in a spot welding processes, the method makes it easy to perform completely automatic measurements of the wear of the stationary electrode. A further advantage is that the method does not need any external sensors or measuring devices to measure the tip wear.

According a preferred embodiment of the second aspect method, a pose transformation is applied to a tool data transformation to correct for the wear. In a preferred embodiment, the tool data transformation is replaced by the corrected tool data transformation in the memory of the robot controller and will be used for the next welding operation. The tool data transformation is a homogeneous transformation that takes the robot wrist coordinate system into the tool coordinate system. The result of the product of the tool data transformation and the pose transformation defines the new TCP.

The third aspect of the invention provides a method of controlling an industrial robot, comprising a control unit and a manipulator including a tool comprising a defined TCP, for calibrating a reference distance between known reference position and an actual position. A level indicating means is brought to comprise a movably attached plate. During movement of the robot, the tool tip is brought to elevate the movable plate into a programmed reference position below an upper stop position level. Then, the tip of the tool is brought to elevate the movable plate from the reference position into the upper stop position creating an actual position. An actual TCP position is read and a reference distance is computed from the difference between the actual position and the reference position. According to a preferred embodiment of the invention, the reference difference is stored in a memory of the control unit.

In a preferred embodiment of the third aspect of the invention, the current tip wear of the tool after a number of production cycles, is measured through computing a difference between the reference distance and an actual distance.

In a further preferred embodiment of the third aspect of the invention, the tool is brought to comprise a first and a second gun arm. The gun is closed with desired gun pressure in the reference position and is then closed during the movement into the upper stop position level. Since the gun tool is brought to be closed in its work position, the reference distance, the current tool wear and the actual distance are in one preferred embodiment of the invention used for computing the gun arm bending in the gun tool in this position. This can be repeated if different gun pressures are used.

When performing spot welding, data for the correlation between the gun force and the arm deflection is a user defined data predefined for each used spot weld gun. Then, during program execution of spot instructions, there is an added robot movement, activated during the same time as the gun pressure is established, to compensate for the gun arm deflection. A movement in the opposite direction is performed after the weld, when the gun is opened, at the same time as the release movement. The method, according the third aspect of the invention, eliminates the need of external sensors and measuring devices. It is easy to make completely automatic measurements of the wear and the gun arm deflection.

The fourth aspect of the invention provides an industrial robot system comprising an industrial robot with a robot tool and a level indicating means. The level indicating means comprises a movably attached plate arranged to be moved by a tip of the tool. In one embodiment of the invention, the level indicating means comprises a plate movement limiting device including a first fixed stop defining an elevation stop level. In another embodiment of the invention, the plate movement limiting device comprises a second fixed stop defining a lowering stop level. In an alternative embodiment of the invention, the movable plate is arranged with a spring suspension. In a preferred embodiment, the movable plate is arranged to pivot about an axis.

In one embodiment of the invention, the industrial robot device is comprised on the industrial robot. According to another embodiment of the invention the industrial robot device is arranged external to the industrial robot and internal in the robot system.

In one preferred embodiment of the invention a computer program comprises instructions to influence a processor to carry out any of the methods mentioned above. A computer readable medium comprises a computer program mentioned above. It is included in the scope of protection that the invention as claimed is used for carrying out any process working in specific positions. The process for working in specific positions is any of the following methods of joining: spot welding, riveting, or clinching. Use of a process comprising laser fibre is comprised in another preferred embodiment of the invention.

It is comprised in the scope of the protection that the method for carrying out the invention is used when performing any of the following methods of joining: spot welding, riveting, or clinching. It is also comprised in the scope of the protection that the industrial robot device is used when performing any of the methods of joining mentioned above.

### BRIEF DESCRIPTION OF THE DRAWING

The invention will be explained in greater detail, by description of embodiments, with reference to the accompanying drawing, wherein:

FIG. 1 is prior art industrial robot welding equipment,

FIG. 2 is a spot welding gun,

FIG. 3 is an offline programmed position of a spot weld,

FIG. 4 is a weld tip colliding with the sheet metal at a point,

FIG. 5 a defines effect of tool wear and corresponding TCP error,

FIG. 5 b is a gap due to the tool wear according to FIG. 7a,

FIG. 6 is a calibration plate installed in good reach of a robot,

FIG. 7 illustrates the wear of a spot weld electrode,

FIG. 8 illustrates the method how to calculate the wear of the tool,

FIG. 9a-e is the tip of the robot tool of FIG. 1 and a mechanical level indicating means.

### DESCRIPTION OF THE PREFERRED EMBODIMENTS

The following description relates to both the method and to the device.

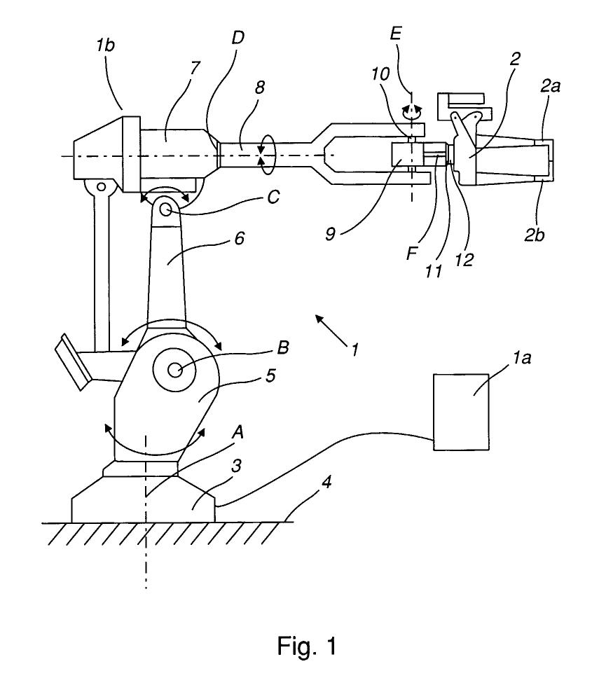

FIG. 1 is an industrial robot system comprising an industrial robot 1 with a control unit 1a, a manipulator 1b and a robot tool, a spot weld gun 2. The industrial robot comprises a foot 3 mounted to a base 4. The foot supports a stand 5, which is arranged to rotate in relation to the foot 3 about a first axis A. The stand 5 supports a first robot arm 6, arranged to rotate in relation to the stand 5 about a second axis B. The first robot arm supports an arm housing 7, which is arranged to rotate in relation to the first robot arm 5 about a third axis C. The arm housing 7 supports a second robot arm 8, arranged to rotate in relation to the arm housing 7 about a fourth axis D, and where the fourth axis D coincides with the longitudinal axis of the second robot arm 8. The second robot arm 8 comprises a wrist housing 9, which is supported by a wrist 10. The wrist housing 9 is arranged to rotate about a fifth axis E, which coincides with the longitudinal axis of the wrist. The wrist housing 9 supports a turn disc 11, which is arranged to rotate about a sixth axis F. The turn disc 11 comprises a tool holder 12, which is adapted for attachment of a tool, such as, for example, a spot welding gun 2.

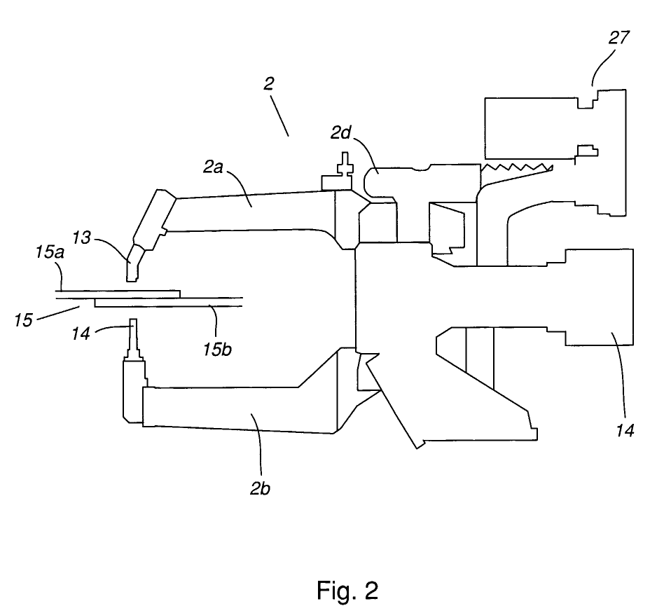

FIG. 2 is a spot welding gun 2, which comprises a first, movable electrode arm 2a, which at its outer free end supports a first welding electrode 13. The welding gun also comprises a second, fixed electrode arm 2b, which at its outer, free end supports a second welding electrode 14. The second electrode arm 2b is rigidly connected to the mounting plate 14 of the gun tool. The welding gun with the first 2a and the second electrode arm 2b is adapted for clamping and joining together at least two sheets of metal 15a and 15b of a work piece 15. It is understood that the welding gun 2 is either attached to the industrial robot 1 or a stationary spot welding apparatus (not shown).

A first yoke 2c is connected to a servo device 27 via a joint 2d as well as to the first, movable electrode arm 2a.

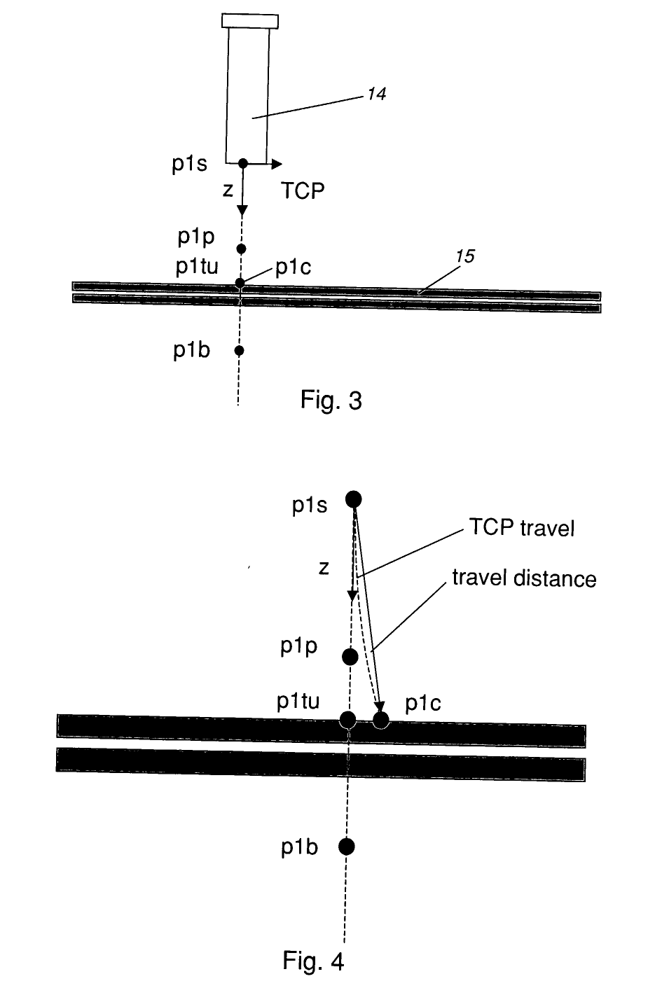

An inaccurately programmed position of a spot weld is shown in FIG. 3. It will inherently exhibit a distance error from the sheet metal. The method according to claim 1 is an automatic method to find the vertical projection p1tu along the z axis of the weld tip onto the sheet metal to be welded, using the robot as a touch probe device to find the surface of the sheet metal.

A weld tip is moved to a safe position p1s in negative tool z direction, as moving the robot in normal control mode to the programmed position p1p may cause a collision if the programmed position happens to be below the sheet metal.

The servo controller of the robot is put into soft mode (soft servo, compliant motion) where the feedback gain of the servo loops are reduced and the integral part is frozen to the current value when soft servo is activated. In this mode, the robot will still moderately follow a slow move command over a short distance, but it will not create excessive force if an obstacle is hit on the way.

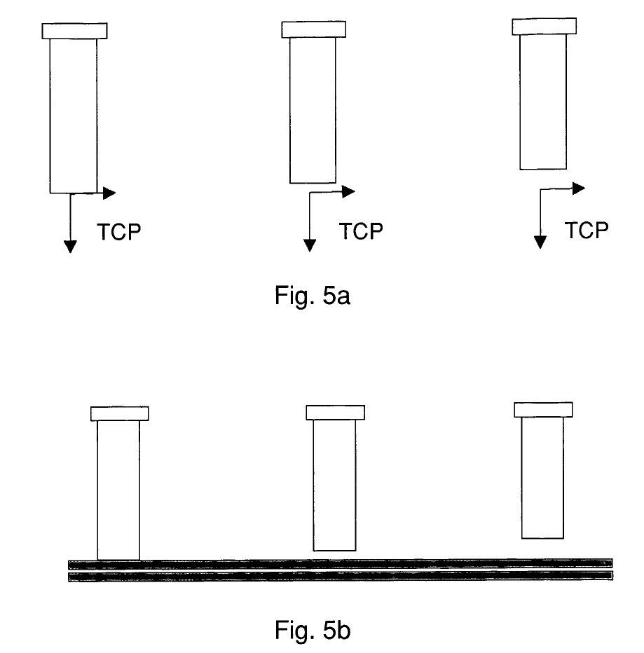

The robot is slowly moved in soft servo mode to a point p1b below the sheet metal, so that at one point in time the weld tip must touch the surface of the sheet metal. Because path accuracy in soft servo is low, the true path will not be on the programmed path between p1s and p1b, but deviate by a few millimetres. The weld tip will therefore collide with the sheet metal at a point p1c (see FIG. 4). Because of the compliant behaviour of the robot, the controller will continue to command position references until p1b is reached, the force between the gun tip and the sheet metal will increase, but not excessively.

The robot is slowly moved in normal control servo mode from pls to p1b and the movement is stopped when the weld tip collide with the sheet metal at a point p1c. The collision with the sheet metal is detected by supervising the motor torques of the robot axes, which increases in comparison to the torques needed for only moving the robot from p1s to p1b when the weld tip gets in contact with the sheet metal. The user can define in advance the touch up force i.e. the force between the work piece and the tip when the robot movement is stopped. From the given force and the knowledge of the robot kinematics the additional torques on the motors of the robot axes created by the touch up can be calculated and give the torque level for the supervision.

After the move command is finished, the actual TCP position, p1c, is read and the travel distance vector d is computed from the difference between p1c and p1s.

$$d = [ \begin{matrix}{d}_{x} \\ {d}_{y} \\ {d}_{z}\end{matrix} ] = [ \begin{matrix}{x}_{C} - {x}_{S} \\ {y}_{C} - {y}_{S} \\ {z}_{C} - {z}_{S}\end{matrix} ]$$

where [x_{c},y_{c},z_{c}] and [xₛ,yₛ,zₛ] denote the TCP position at p1c and p1s, respectively, in the current coordinate frame.

The distance vector d is projected onto the direction of the tool using the inner product

d*=dₓ*zₓ+d_{y}*z_{y}+d_{z}*z_{z},

where [zₓ,z_{y}z_{z}] is a unit vector defining the direction of the z-axis of the tool in the same coordinate frame as used for defining the targets p1c, p1s etc.

d* is the shortest distance between the programmed position p1p and the sheet metal. The touch-up point p1tu is computed by adding the distance d* to the programmed point p1p in the z-direction of the tool. The position p1tu is permanently stored in memory. It will be used for executing the spot weld program. The robot is moved to a target p2p corresponding to a second spot weld, and the same procedure is repeated until all targets are processed.

Thus, FIG. 3 is a situation when the servo controller of the robot is put into normal mode and the point p1c coincides with p1tu.

This procedure is applied when the spot welding cell is being set up and, if necessary, from time to time when the position of the work piece varies due to changes in part tolerance over production time. It can be automatically and subsequently applied to all spot welds without human interaction. After this procedure, the spot weld targets are known with high accuracy and a gun equalizer is no longer required.

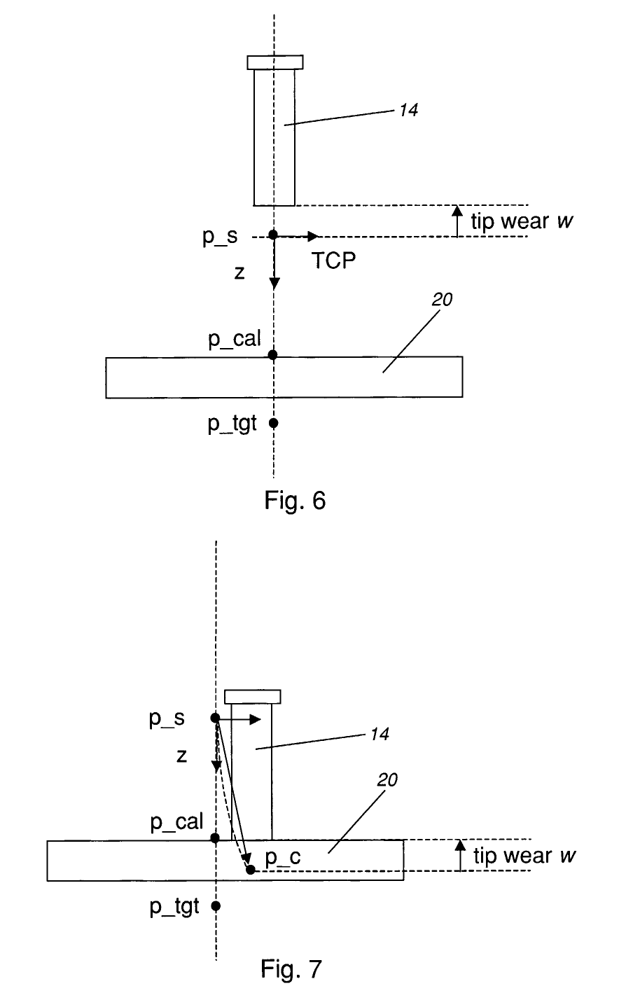

Further, the invention describes how the tip wear can automatically be compensated by using a similar procedure to the method described above. FIGS. 5a and 5b show the effect of tip wear causing TCP error.

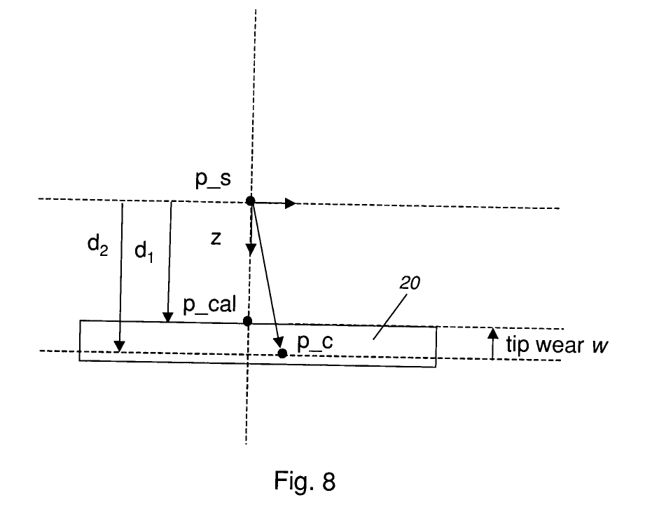

FIG. 6 shows a calibration plate 20 that is installed in good reach of a fixed electrode 14 of a spot welding gun.

In a first step, with a well-calibrated TCP, a target p_cal on the surface 19 of the calibration plate 20 is programmed and stored in a memory of the robot system, with a tool orientation normal to the surface of the calibration plate 20.

Then, a second target p_s is programmed and stored in memory at a safe position above in z direction above p_cal. The distance is greater than the maximum wear expected on the gun tip. The tool orientation at p_s must be perpendicular to the normal of the calibration plate.

After a certain number of spot welds when tip wear can be expected, the robot is moved to the safe target p_s. The z axis of the tool 2 now points towards the calibration plate 20 in a direction normal to the surface.

The robot is moved in normal control mode as already described above to a target p_tgt defined below the calibration plate, lying on the straight line through p_c and p_cal.

Alternatively, the robot axes are put in a soft mode with moderate softness as already described above and the robot is moved in soft mode to a target p_tgt defined below the calibration plate, lying on the straight line through p_c and p_cal.

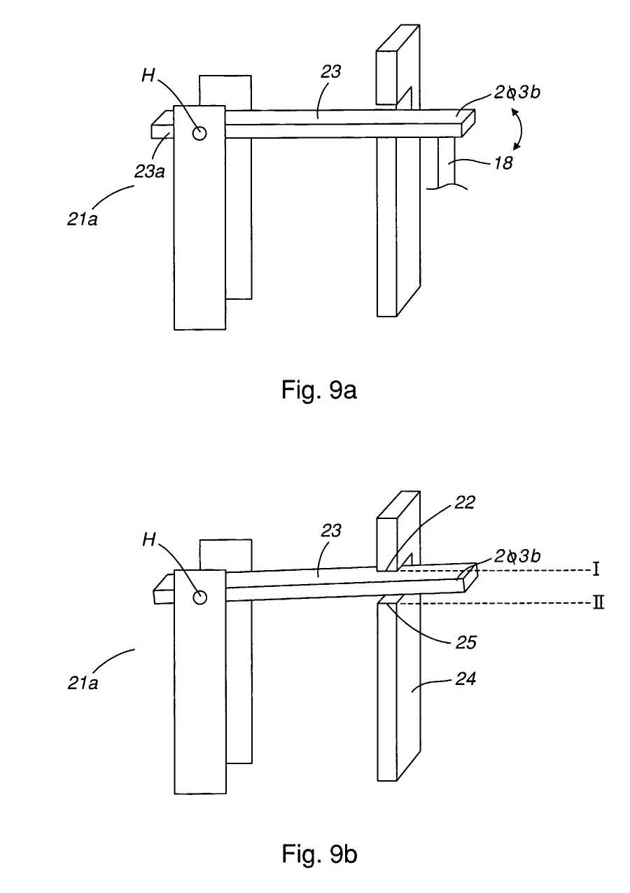

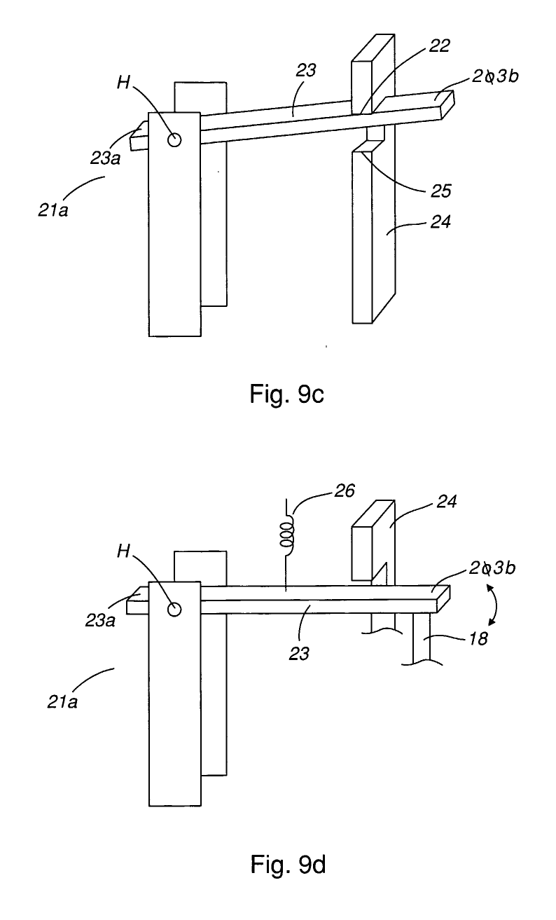

After the tip touched the surface 19, the robot position p_c at that position is read out and stored in memory (see FIG. 6). The wear W is computed by the difference of the two inner products d₁ and d₂, as depicted in FIGS. 7 and 8.

d₁=(x_{c}−xₛ)*z_{z}+(y_{c}−y_{z})*z_{y}+(z_{c}−zₛ)*z_{z}

d₂=(x_{cal}−xₛ)*z_{z}+(y_{cal}−yₛ)*z_{y}+(z_{cal}−zₛ)*z_{z}

w=d₁−d₂

where [x_{cal},y_{cal},z_{cal}] and [x_{c},y_{c},z_{c}] denote the TCP position at p_cal and p_c, respectively, and ( ) is a unit vector defining the direction of the z-axis of the tool in the same coordinate frame as used for defining the targets p_c, p_cal, and p_tgt.

In a preferred embodiment of the invention, a pose transformation Tw is applied to the tool data transformation Tt to correct wear. The tool data transformation is a homogeneous transformation that takes the robot wrist coordinate system into the tool coordinate system. The result of the product T_{new}=Tₜ*T_{w} defines the new TCP.

In a final step, the old tool data transformation Tₜ is replaced by tool data transformation T_{w} in the memory of the robot controller and will be used for the next welding operation.

Further the invention comprises a mechanical level indicating means comprised in an industrial robot system including an industrial robot with a robot tool for the purpose of performing the methods described above.

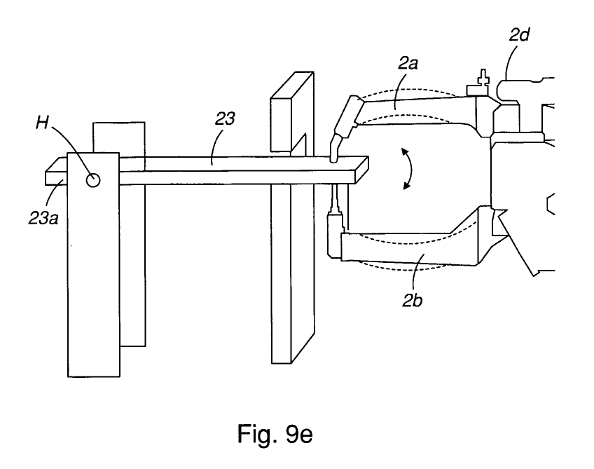

FIG. 9a-9e is a level indicating means 21 arranged in the working area of an industrial robot system according to FIG. 1. The level indicating means comprises an elongated plate 23 attached in a first end 23a and arranged to be pivotally moved about an axis of rotation H. The plate 23 is brought to be moved by a tool tip 18 of the robot.

FIG. 9b is the level indicating means 21a comprising a plate movement limiting device 24 including a first fixed stop 22 defining an elevation stop level I and a second fixed stop 25 defining a lowering stop level II.

FIG. 9c is the level indicating means 21 with the plate 23 moved into the upper stop level I by the tool tip 18. FIG. 9d is a plate 23 arranged with a spring suspension 26 as an alternative to the second fixed stop.

The second end 23b of the plate is movably arranged such that it is possible for a robot tool e.g. a spot weld gun to reach the second end 23b and preferably on the lower side 23c of the movable plate. In FIG. 9e, the tool is a spot weld gun in a closed work position p_{work} clamping a work piece 15.

1. A method of controlling an industrial robot, comprising a control unit and a manipulator including a tool with a tip comprising a defined tool center point, for determining an actual position corresponding to an inaccurate programmed position for a spot on a surface of a work piece, the method comprising:
bringing the tip of the tool to be moved from a first programmed position at a distance from the surface in a defined direction towards the work piece,
bringing the tip to collide with the surface at a collision point, and
computing the actual position from the distance between the collision and the first programmed position in the defined direction of movement.

2. The method according to claim 1, further comprising:
moving the tool towards a second position programmed to be positioned behind the work piece seen in the direction of movement.

3. The method according to claim 1, further comprising:
stopping the movement of the tip when a created force between the work piece and the tip has increased to a predefined value.

4. The method according to claim 3, further comprising:
detecting the created force by supervising motor torques of axes of the robot.

5. The method according to claim 3, further comprising:
controlling the created force by soft servo.

6. Use of the method according to claim 1 when setting up an industrial robot spot welding cell.

7. A method of controlling an industrial robot comprising a control unit and a manipulator including a tool comprising a defined tool center point, for determining a distance error between an offline programmed position for a target on a surface of a calibration plate and a corresponding actual position due to wear of the tool, with the tool orientation normal to the surface, the method comprising
moving the robot from a first position with the tool orientation normal to the surface such that the tool is brought in touch with the surface of the calibration plate creating an actual position,
reading an actual tool center point position to define a coordinate system,
computing two reference distances from differences between the tool center point positions of the actual position and the first position, and
computing a wear by the difference of the two reference distances.

8. The method according to claim 7, further comprising:
applying a pose transformation to a tool data transformation to correct for the wear.

9. The method according to claim 8, further comprising:
storing a tool data transformation in a memory of the control unit and
using the tool data transformation for the next welding operation.

10. The method according to claim 7, further comprising:
moving the robot in normal control servo mode.

11. The method according to claim 7, further comprising:
moving the robot in soft servo mode.

12. A method in an industrial robot system comprising an industrial robot, including a control unit and a manipulator with a tool comprising a defined tool center point, and a level indicating means for determining a reference distance, the method comprising:
bringing the level indicating means to comprise a movably attached plate,
during movement of the robot, bringing the tool tip to elevate the movable plate into a programmed reference position below a stop level,
bringing the tool tip to elevate the movable plate from the reference position into an upper stop position creating an actual position,
reading an actual tool center point position is read, and
computing a reference distance from the difference between the actual position and the reference position.

13. The method according to claim 12, further comprising:
storing the reference difference in a memory of the control unit.

14. The method according to claim 12, further comprising:
determining the wear of the tool after a number of production cycles through computing a difference between the reference distance and an actual distance.

15. The method according to claim 14, further comprising:
bringing the tool to comprise a first and a second gun arm,
bringing the gun tool to be closed in its closed work position,
using the reference distance, the current tool wear and the actual distance for computing the gun arm bending in the gun tool in its closed work position.

16. An industrial robot system, comprising:
an industrial robot;
a robot tool;
a level indicating means comprising a movably attached plate arranged to be moved by a tool tip of the tool.

17. The device according to claim 16, wherein the level indicating means is arranged to comprise a plate movement limiting device including a first fixed stop defining an elevation stop level.

18. The device according to claim 17, wherein the plate movement limiting device is arranged to comprise a second fixed stop defining a lowering stop level.

19. The device according to claim 16, wherein the movable plate is arranged with a spring suspension.

20. The device according to claim 16, wherein the movable plate is adapted to pivot about an axis.

21. A computer program product, comprising:
a computer readable medium; and
instructions recorded on the computer readable medium to influence a processor to carry the steps of
bringing a tip of a tool to be moved from a first programmed position at a distance from a surface in a defined direction towards a work piece,
bringing the tip to collide with the surface at a collision point, and
computing an actual position from the distance between the collision and the first programmed position in the defined direction of movement.

22. (canceled)

23. Use of a method according to claim 1, an industrial robot device or a computer program product for carrying out any process working in specific positions.

24. The use according to claim 23, wherein the process for working in specific positions is any of the following methods of joining: spot welding, riveting, or clinching.

25. The use according to claim 23 in processes comprising laser fiber.

26. Use of a method in an industrial robot device according to claim 16 or a computer program product for carrying out any process working in specific positions.

27. Use of a method, an industrial robot device or a computer program product according to claim 21 for carrying out any process working in specific positions.
